(19) United States
(12) Patent Application Publication
(10) Pub. No.: US 2018/0057975 A1
(43) Pub. Date: Mar. 1, 2018

(54) PROCESS FOR MAKING A FABRIC LABEL CONTAINING ONE UNIQUE INFORMATION AND RESPECTIVE AUTHENTICATION PROCESS

(71) Applicant: CODING MANAGEMENT S.A., Luxembourg (LU)

(72) Inventors: Arno MONTORFANO, Luxembourg (LU); Paul Peter WILKINSON, Luxembourg (LU); Giuseppe CROVATO, Azzano Decimo (IT)

(21) Appl. No.: 15/560,307

(22) PCT Filed: Mar. 23, 2016
(86) PCT No.: PCT/IB2016/051628

§ 371 Date: Sep. 21, 2017

(30) Foreign Application Priority Data
Mar. 24, 2015 (IT) MI2015A000431

(51) Int. Cl. D03D 1/00; D03D 13/00; D06H 1/02; G09F 3/00

(52) U.S. Cl. CPC D03D 1/0011; D03D 13/004; G09F 2003/0282; G09F 3/0297; G09F 3/0294; D06H 1/02

(57) ABSTRACT

Process for making a fabric label (10) containing one piece of unique information; characterized by comprising the following steps:
providing a fabric piece (7) comprising a first woven pattern (2) made by a predetermined arrangement combination of weft threads with respect to the warp threads;
applying at least one second decorating pattern (4) on said fabric piece (7) to make at least one decoration for a label (10) to be made;
associating at least one piece of variable information (5) adapted to uniquely identify a label (10) to be made;
detecting a reference image (12) for every second decorating pattern (4), associated with a label (10) to be made; each reference image (12) being adapted to show the reciprocal position of every second decorating pattern (4) with respect to the first woven pattern (2);
storing the picture in an association database (14).

### FIELD OF THE INVENTION

The present invention concerns the field of the individual identification of items by means of labels made of fabric and anti-counterfeiting systems of labels made of fabric. More in particular, the present invention concerns a process for making a label provided with an anti-counterfeiting system and the respective authentication process.

### KNOWN ART

As known, the individual identification of items of clothing or fashion accessories is obtained also by fabric labels containing numerical or alphanumeric strings or codes of mono/two-dimensional types both readable by electronic equipment, such as for example bar codes or QR-codes. These codes are realized, for example, by weaving processes able to generate unique labels. Alternatively, these codes are realized by digital printing processes. These processes are, in fact, the only ones able to provide large quantities of labels containing variable data readable with both visual recognition and electronic equipments.

However, the Applicant observed that products labeled through these types of labels are not inherently protected from counterfeiting. As a matter of fact, the Applicant observed that the same label may be reproduced with reasonable simplicity unless additional anti-counterfeiting elements are applied thereon, thus rendering its reproduction more complex and then the counterfeit more evident.

In any case, such techniques complicate the production process and have little effectiveness as these additional anti-counterfeiting elements are not usually serialized.

Another technique used to render the label hard to reproduce is to identify defects on them, for example by laser beam analyses or high-definition cameras, which are randomly generated by the production process, and the respective positions of these defects and then, during a subsequent authentication step, to identify part of the same defects by specific optical equipments. These techniques, particularly on fabrics, have the disadvantages that (i) during the use of the item or simply while washing it, the defects tend to be corrupted and become more difficult to recognize, if not impossible, and that (ii) the detection and authentication, and therefore the defect detection, needs the use of equipments not available for a consumer and even hardly available for an inspector.

Therefore the Applicant found the need of developing a novel label comprising an anti-counterfeiting system, a production process of the same and an authentication process which would solve limitations of the technology in accordance with the afore mentioned techniques.

### SUMMARY OF THE INVENTION

Therefore the invention concerns, in its first aspect, a process for making a fabric label containing one piece of unique information; characterized by comprising the following steps:
providing a fabric piece comprising a first woven pattern made by a predetermined arrangement combination of weft threads with respect to the warp threads, and/or by embroidering, even partially, a pattern on the piece itself;
applying at least one second decorating pattern on said fabric piece to make at least one decoration for a label to be made;
associating at least one piece of variable information adapted to identify a label for at least one label to be cut;
detecting a reference image for every second decorating pattern, associated with a label to be made; each reference image being adapted to show the reciprocal position of every second decorating pattern with respect to the first woven pattern;
storing the reference image (for example a picture) or a resumptive parameter of the image in a database.

In the scope of the present invention:

the expression “piece of information of variable type” means a piece of information being different for each made label and adapted to identify the label on which is placed.

the expression “fabric” means a material obtained by weaving, or inserting, weft yarns in a warp. The woven material, in addition to natural, artificial or synthetic conventional yarns, may also comprise materials such as non-woven fabric, coagulated material, leather or the like, on which decorations similar to the “first woven pattern” have been applied.

In the above said aspect, the present invention can have at least one of the preferred characteristics hereinafter described.

Advantageously, the step of applying at least one second decorating pattern comprises a step of printing at least one second decorating pattern on said fabric piece.

Conveniently, the step of storing the detected reference image in an association database comprises a step of electronically storing every second decorating pattern associated with a label to be made, in conjunction with at least one piece of variable information adapted to identify a label. Preferably, the process comprises a step of cutting said fabric piece to make at least one label.

Advantageously, in the step of applying at least one second decorating pattern on said fabric piece, a plurality of second decorating patterns is applied, each of them being even different from one another and adapted to be positioned on a label.

Conveniently, the weft threads and/or the warp threads of said fabric piece comprise pigments or have such a chemical composition to become particularly visible if illuminated in the infrared ray range.

Alternatively, the weft threads and/or the warp threads of said fabric piece comprise pigments or have such a chemical composition to become particularly visible if illuminated in the ultraviolet ray range.

Alternatively, the weft threads and/or the warp threads of said fabric piece comprise or have such a chemical composition to become particularly visible if illuminated in the ultraviolet and infrared ray range.

Preferably, said piece of variable information unique for every label is represented with an alphanumeric code and/or a mono/two-dimensional code.

Advantageously, the step of detecting a reference image comprises making a digital picture.

Preferably, the step of making a digital picture comprises subjecting the label to an artificial illuminant with spectra at least partially in the infrared and/or ultraviolet range, in order to improve the visibility of the first woven pattern and its position with respect to the second decorating pattern.

Thanks to the particular illumination conditions and, in some cases, to the use of weft threads and/or, alternatively, warp threads with the above described specific optical characteristics, it was also possible to obtain satisfactory pictures in order to store the reciprocal positioning between the first woven pattern and the second decorating pattern of the label, with low resolution (about 100 DPI in the grayscale) and then with a poor memory usage during the storing step. This use aspect of the threads sensitive to some illuminants then allows taking pictures in the grayscale with low resolution and then rendering the first woven pattern poorly evident in conditions of natural light and then less troublesome for the second decorating pattern printed on the fabric piece.

Advantageously, the process may also comprise the steps of:
calculating the coordinates of distinctive elements of the first woven pattern, or parts of them, with respect to reference points of the second decorating pattern;
storing said coordinates in an association database in conjunction with at least one piece of variable information adapted to identify a label.

This variation can be very useful for reducing the necessary storage in the database.

According to another aspect the present invention concerns a method of authenticating a label made by the above described process, the method comprising the steps of:
providing the label of which the authenticity has to be verified;
detecting an image of the label of which the authenticity has to be verified;
comparing the detected image with a reference one in order to verify that the reciprocal position of the first woven pattern, with respect to the second decorating pattern present on the detected image (or vice versa) is identical to the reciprocal position of the woven pattern with respect to the second decorating pattern present on the reference image (or vice versa). The step of detecting the image could be a simple visual observation of the label.

Conveniently, the step of comparing the detected image with a reference one comprises sending the reference image from a remote server associated with an association database containing the reference images to a smartphone, tablet, PC or any object able to talk with the database.

In this way the label authenticity check becomes easy, quick, non-destructive, obtainable through equipments available for the user and without the need of physically sending the labels to a checking center.

Conveniently, the step of detecting a label image comprises making a digital picture of at least one portion of the label.

The authentication method could be also implemented with the steps of:
calculating the coordinates of distinctive elements of the first woven pattern, or parts of them, with respect to reference points of the second decorating pattern,
comparing such coordinates with the coordinates of the elements, or parts of them, detected in the reference image.

According to another aspect the present invention concerns a label made by the above described process.

Advantageously, the label is made of fabric comprising weft threads and fabric threads woven together so that a first woven pattern is obtained;

said woven pattern comprising at least one distinctive element obtained through a specific and controlled arrangement of the weft threads with respect to the warp threads;

The label further comprising at least one second decorating pattern applied on the fabric and at least one piece of variable information adapted to identify a single label;
the reciprocal position of said at least one distinctive element, with respect to the second decorating pattern, realizing an authenticity element of the same label. Conveniently, the first woven pattern could also be partially or totally obtained by an embroidering process of the pattern.

In other terms, the reciprocal position of said at least one distinctive element, with respect to the second decorating pattern, realizes a unique and non-reproducible “fingerprint” of the label.

Preferably, the label comprises a second decorating pattern unique for the label on which it is placed and different from the second decorating patterns of the other made labels.

According to another aspect the present invention concerns an anti-counterfeiting system of a label, comprising
at least one label made and realized as described above;
at least one means for detecting the reciprocal position of said at least one distinctive element with respect to said second decorating pattern;
at least one means for storing the reciprocal position of said at least one distinctive element with respect to said second decorating pattern.

Advantageously, the means for detecting the reciprocal position of said at least one distinctive element with respect to said second decorating pattern comprises a means adapted to detect a reference image associated with a label and representing the reciprocal position of said at least one distinctive element with respect to every second decorating pattern.

Preferably, the means for storing the reciprocal position of said at least one distinctive element with respect to said second decorating pattern comprises an electronic means for storing and saving the reference image, or a resumptive parameter of the reference image, in a database.

Preferably, the piece of variable information adapted to identify a single label comprises an URL unique for every label and adapted to allow retrieving the reference image stored in the database by inserting such an URL in an Internet browser.

### BRIEF DESCRIPTION OF THE DRAWINGS

Further characteristics and advantages of the invention will be more evident from the detailed description of some preferred embodiments, but not exclusive, of a new process for making a fabric label containing at least one piece of unique variable information and an anti-counterfeiting system according to the present invention and the respective authentication process. This description will be explained hereinafter by referring to the attached drawings provided for illustration purposes only and without limitation, in which:

FIG. 1a and 1b are two embodiments of a fabric piece respectively comprising a first and a second woven pattern according to the present invention;

FIG. 2 is a schematic view of some steps of the process for making a fabric label containing at least one piece of unique variable information and an anti-counterfeiting system according to the present invention;

FIG. 3 is a schematic view of a fabric piece adapted to realize several labels contemporaneously;

FIG. 4 is a schematic view of the step in which a portion of the fabric piece adapted to realize a label is taken, and containing at least one piece of variable information according to the present invention and the subsequent step of storing the taken image; and

FIG. 5 is a schematic view of a step of the method of authenticating a label.

### DETAILED DESCRIPTION OF EMBODIMENTS OF THE INVENTION

The process according to the present invention allows realizing a fabric label 10 containing an anti-counterfeiting system in accordance with the present invention.

The label 10 is made of a fabric comprising weft threads and warp threads woven together, as hereinafter described in more detail. Both the weft and warp threads can also contain, or be coated with, or be constituted by, materials having specific optical characteristics not necessarily visible with illumination conditions in the visible light range, but visible if illuminated with specific illuminants having spectra with prevalent energies in the infrared or ultraviolet spectrum, or both. The weft threads can also have different colors from the warp ones. Alternatively, the weft and warp threads can all have the same color or a variable color.

In the present embodiment described by way of example, the process for making a unique fabric label according to the present invention starts with providing a fabric piece 7. The fabric piece 7 comprises a first woven pattern 2 made by a predetermined arrangement combination of weft threads with respect to the warp threads.

By way of example, in figures la and lb two embodiments of fabric pieces 7 according to the present invention are shown, both containing a first woven pattern 2.

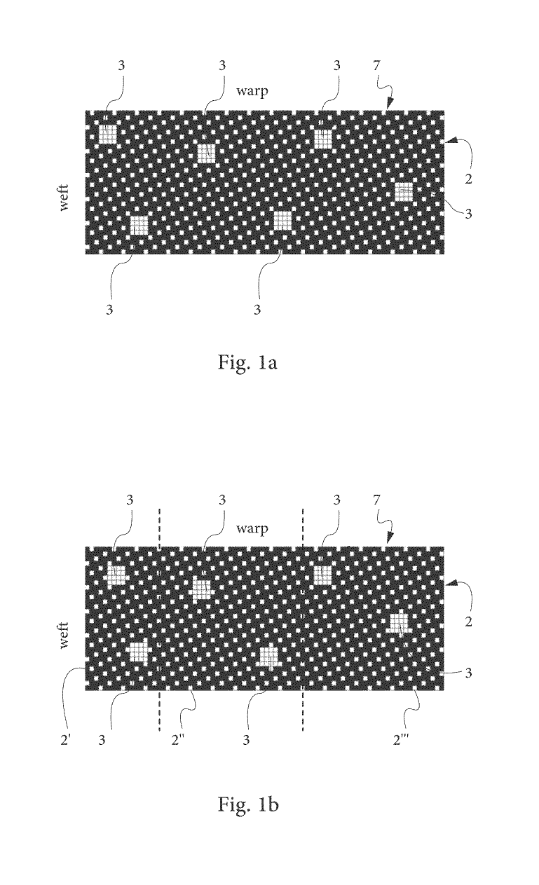

In particular in FIG. 1 a first woven pattern 2 is obtained by controlling the position of the weft threads with respect to the warp ones; in particular, referring to FIG. 1, the white areas are those in which the weft thread is in upper position, referring to the figure, with respect to the warp thread, the black areas are those corresponding to the opposite arrangement of the weft thread with respect to the warp ones. In this embodiment the white squares, also named hereinafter distinctive elements 3 of the woven pattern, are constituted by four weft threads well visible from the highlighted side.

The distinctive elements 3 for every woven pattern are usually more than one, but it can also be only one having a very complex form (for example a background or logo pattern), without departing from the protection scope of the present invention.

Still referring to the embodiment shown in FIG. 1, it is shown as the woven pattern 2 can also be repeated in the fabric piece 7, different fabric pieces 7 can have the same woven pattern, but the utmost security is achieved when the made fabric pieces 7, each of them being adapted to realize a label batch, have a different woven pattern 2. Preferably, the fabric piece 7 intended to make a label batch comprises a plurality of different woven patterns 2, this can be achieved by controlling the weaving arrangement of the warp threads with respect to the weft threads.

In FIG. 1b a second embodiment of the fabric piece 7 is shown, which comprises several woven patterns 2 inside the same fabric piece 7, specifically three 2′, 2″, 2′″ of them and that are still obtained by controlling the position of the weft threads with respect to the warp ones in a predetermined way. By changing the arrangement and the reciprocal position of the weft threads with respect to the warp threads in a controlled way, a great number of woven patterns 2 can be obtained, depending on the combination pattern and the weaving resolution and, consequently, a high number of labels all containing at least one woven pattern 2 different from the other labels 10.

Alternatively, the woven pattern 2 can be obtained from a predetermined embroidery on the same fabric piece 7.

After the fabric piece 7 has been provided, at least one second pattern named decorating pattern 4 is applied, in order to realize at least one embroidery on every label 10 to be made.

If the fabric piece 7 is intended to realize several labels 10, a plurality of second decorating patterns 4 are applied on the fabric piece 7, as shown for example in FIG. 3, each of them being adapted to be positioned in the portion of the fabric piece 7 adapted to produce a single label 10. The second decorating patterns 4 can also be a graphical representation of any type, for example a writing, a drawing, a photographic image, a trademark or a logo. The second decorating pattern 4 can be the same for all the labels 10 belonging to the same fabric piece 7, as in FIG. 3, otherwise it can be different. In other terms, on the same fabric 7 even only one decorating pattern 4 can be applied again and again, every repetition will be intended for realizing a label 10. On the other hand, every label 10 will be able to contain even more than one second decorating pattern 4.

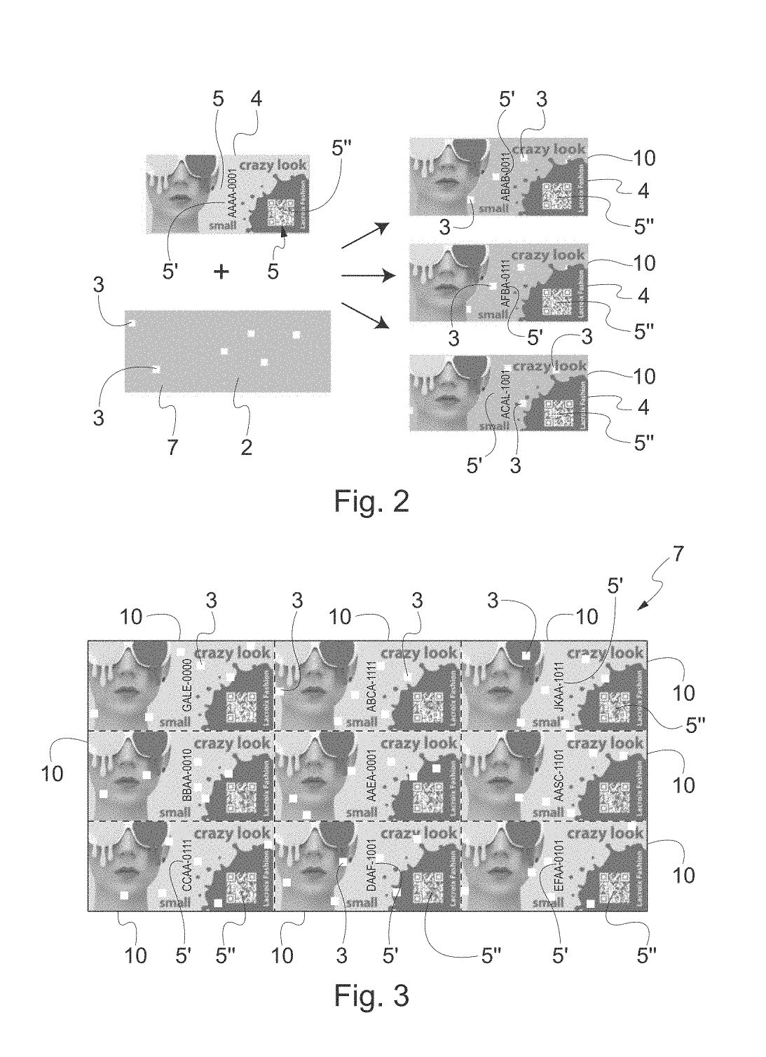

In FIG. 2, it can be seen as by applying the same decorating pattern 4 on the fabric piece 7 different labels 10 can be realized, specifically in the number of three, each of them being unique depending on the specific position of the first woven pattern 2 and, in particular, of its distinctive elements 3 with respect to the corresponding decorating pattern. The applying step of the second decorating patterns 4 on the fabric piece 7 occurs, preferably, by digital printing techniques having the ability of printing with variable graphics.

In particular, such a step occurs through a technique of heat transfer printing, mono- or multichromatic, by the use of inked ribbons.

The applying step of the second decorating patterns 4 could be implemented, alternatively or in combination with the preceding one, through an inkjet printing technique by applying the inkjet directly to the fabric piece 7.

The applying step of the second decorating patterns 4, still alternatively or in combination with one or more of the preceding ones, could occur through an indirect inkjet printing that consists in printing the second decorating pattern firstly on a medium sheet, typically paper or plastic, and then in transferring the second decorating pattern 4 preprinted on the sheet to the fabric piece 7, by applying heat and pressure. In this case, media and inks suitable for this type of heat transfer are used for the printing.

The applying step of the second decorating patterns 4, still alternatively or in combination with one or more of the preceding ones, could occur through pad printing or silk-screen printing techniques.

Subsequently or during the step of applying the second decorating patterns 4 to the fabric piece 7, a step of applying at least one piece of variable information 5 to the portion of the fabric piece going to generate another label, occurs. The piece of associated variable information 5 is unique for every label 10 to be made and, therefore, is adapted to identify a label 10 and, directly or indirectly, its reference image 12.

The piece of variable information 5 can also be contained in the first woven pattern.

Each piece of variable information 5 is adapted to identify only one label.

Various variable information 5 can be associated with each label 10 to be made for the identification thereof and can contain additional information about the product associated with the label 10 or the production batch of the product and/or label 10.

Variable information 5 can be represented by alphanumeric strings, as the piece of variable information 5′ of FIGS. 2 and 3.

Alternatively, variable information 5 can be represented by electronically readable bar codes; the bars of said codes having a minimum width from 0.1 and 3 mm, preferably from 0.3 to 1 mm.

Still alternatively, variable information 5 can be represented by two-dimensional codes 5″, such as for example QR-codes of FIGS. 2 and 3, that can be read electronically and have single item of information with width and height from 0.1 to 3 mm, preferably from 0.2 to 1 mm; the Applicant also implemented labels having two-dimensional codes of Datamatrix or Aztec type, and other types of codes could be used without departing from the protective scope of the present application.

As shown in FIGS. 2 and 3, for every label 10 there can be much variable information 5 adapted to identify a label 10. In the embodiment shown in FIGS. 2 and 3, each label 10 does comprise a first piece of variable information 5′ depicted by an alphanumeric string and a second piece of variable information 5″ depicted by a QR-code.

Alternatively, variable information 5 can be represented by other coding typologies or specific distinctive elements, such as controlled pattern alterations, without departing from the protection scope of the present invention.

Variable information 5′, 5″ can be applied to the fabric piece 7 through the afore mentioned printing techniques in reference to the step of applying the second decorating patterns 4 or they can be woven during the production step of the fabric piece 7.

Advantageously, in order to reduce the cycle time, variable information 5′, 5″ can be applied to the fabric piece 7 during the step of applying the second decorating pattern 4.

In other terms, while the second decorating patterns 4 are printed on the fabric piece 7, also the variable information 5 are printed in the shape of codes or alphanumeric codes, on the fabric pieces 7.

Alternatively, the application of the second decorating patterns 4 and variable information 5 onto the fabric piece 7 can occur in more than one stage of which at least one is digital (precisely that one for applying the variable information 5).

If the fabric piece 7 is intended for making several labels 10, a step of cutting the fabric is needed, after the second decorating patterns 4 and the variable information 5 have been applied.

The cutting step can occur immediately after the step of applying the second decorating patterns or immediately after the step of associating the second decorating patterns 4 and the variable information 5.

Alternatively, the cutting step can occur in a more advanced process step, without departing from the protection scope of the present invention.

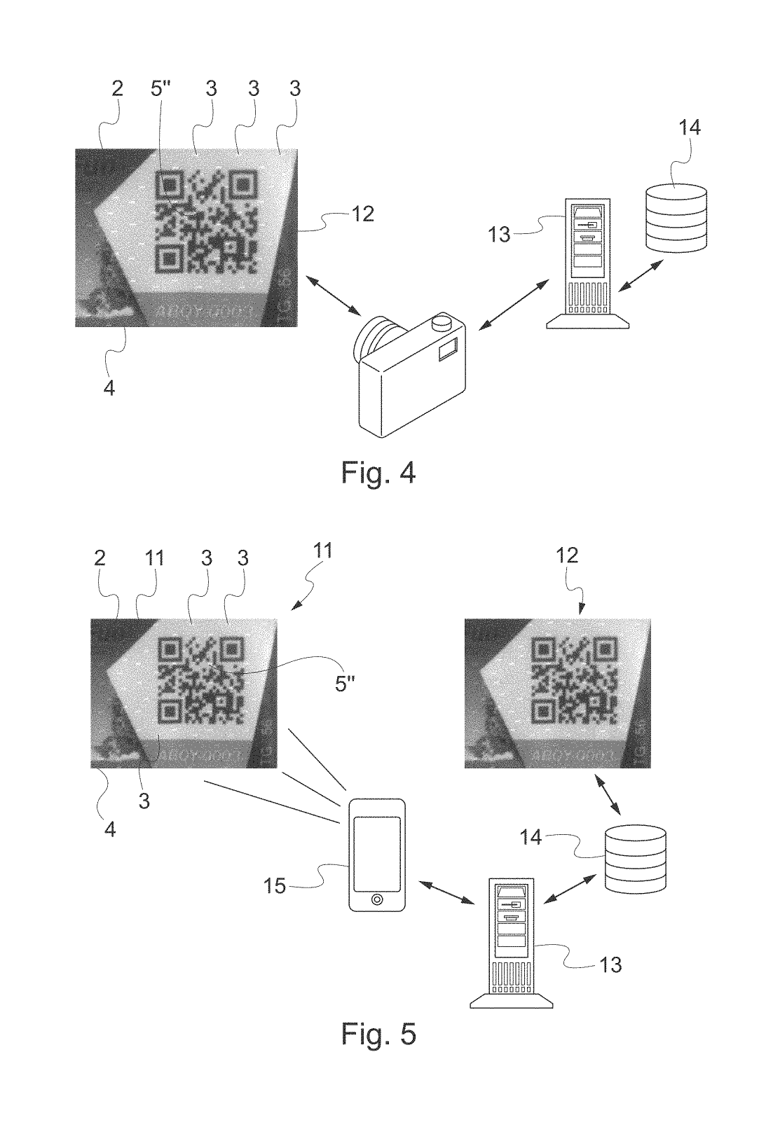

After the step of associating the second decorating patterns 4 and associating the variable information 5, as shown in FIG. 4 a picture is taken of every label and, in particular, for every second decorating pattern 4 the image taken by the picture is adapted to denote the reciprocal position of every second decorating pattern 4 with respect to the first woven pattern 2 below (or vice versa).

Preferably, the pictures are digital pictures just made by digital technique, and for each label 10 they show the reciprocal position of the woven pattern 2 and, in particular, of the elements 3 composing it, with respect to the second woven pattern 4; in this way an non-reproducible unique image is generated, that will be the reference image 12.

Referring to the embodiment shown in figure, it can be seen how the distinctive elements 3 of the woven pattern 2, i.e. the specific recurring distinctive element 3 given by the arrangement of the warp threads with respect to the weft ones and for convenience denoted by white squares, could be positioned differently with respect to the second decorating pattern 4 applied above the fabric piece 7. As a matter of fact, by applying the second decorating pattern 4 on the fabric piece 7 or on a portion thereof containing a first woven pattern, the two patterns, respectively a first woven pattern 2 and a second woven pattern 4, are reciprocally positioned uniquely with respect to all the other made labels 10, thus obtaining a unique and hardly reproducible combination, within the limits of the current technique, constituting the anti-counterfeiting system of the label itself.

Processes of the known art for printing or applying decorations on a fabric are not indeed able to control this relative positioning.

Therefore, the photographic reference images 12 reproduce, for each label or portion thereof, the afore mentioned combination of reciprocal positions of the first woven pattern 2 with respect to the second woven pattern 4. The photographic images, used when stored as reference images 12, may be taken before or during the cutting of the fabric piece 7.

Advantageously, color photographs or black-and-white photographs can be made or they can be made by infrared cameras and/or by subjecting the fabric piece to illuminants in the visible range and/or in the ultraviolet and/or infrared range.

By way of example, in FIG. 4 it can be seen as the fabric piece 7, or a portion thereof, containing at least one piece of variable information 5 and a second decorating pattern 4, or a portion thereof, are photographed in the grayscale with a digital camera so that to obtain a unique image representing at least one portion of every future label 10. Particularly, approximately always the same area of the future labels 10 is photographed and the first piece of variable information 5′, denoted by the alphanumeric string, and/or the second piece of variable information 5″, denoted by the two-dimensional code, are included in the photos.

In the case shown in FIG. 4, in order to reduce the file size to be stored by a resolution reduction, the portion of the fabric piece 7 corresponding to a future label 10 has been illuminated, even though not shown, by a light with a predominant spectrum portion in the UV area.

The UV light allows highlighting the distinctive elements 3 of the surface weft since the threads of the same weft have been coated/contain substances that, once illuminated with UV light, tend to become very visible in the visible range. In the specific case of FIG. 4, the picture in the grayscale, having low resolution al very little size of about 20 KB (in jpg format), has been stored in a database 14.

The second piece of variable information 5, denoted by the two-dimensional code 5″, is the lookup index of the reference image.

Anyway, it is possible to make the same picture without specific illuminants and/or with a higher resolution and/or colored without departing from the protection scope of the present invention.

Therefore, once a unique image for every label 10 has been obtained, such an image, named reference image 12, is stored in a database 14 and will be the comparison model to determine subsequently the authenticity of the label.

Subsequently the fabric piece 7 is cut to obtain the single labels 10.

It is further possible to make the labels singularly or to cut them before making the above described pictures.

Once the labels 10 have been commercialized, it is very simple to ascertain their authenticity and whether they have been counterfeited or not. Referring to FIG. 5 when a user, for example a dealer or an inspector or a consumer, has to verify the authenticity of a label 10 and to ascertain whether it has been counterfeited or not, it will be sufficient to detect an image 11 (for example by a visual observation) of the same label 10 and compare it visually with a reference one 12 made during the production process.

The reference image 12 is retrieved in the database 14 by the variable information 5 depicted on the same label 10. In the specific example, the retrieval of the reference image 12 is possible by inputting the coded URL in the QR-code in any Internet browser, then the URL points to the machine 13 connected to the database 14.

Once the reference image 12 has been obtained, the inspector will only have to verify the position and shape of the elements 3 detected on the real label with the elements 3 highlighted on the reference image 12; said visual comparison, carried out by the inspector between the reference image 12 and the image of the label 11 found on the market, will detect whether the label on the market is authentic or not.

The label 11 found on the market will be authentic only if the reciprocal position of the first woven pattern 2 and the second decorating pattern 4, and in particular the reciprocal position of the distinctive elements 3 with respect to the second decorating pattern 4, will correspond to the reciprocal position between the first woven pattern 2 and the second decorating pattern 4, the latter being in the reference image 12.

Any misalignment between the woven pattern 2 and the second decorating pattern 4 with respect to the position of the same elements in the reference image 12 is unquestionability indicative that the label 10 is not original.

As an alternative to the storage of the image 12, it is possible to determine one or both the coordinates of the elements 3 with respect to one or more reference points of the second decorating pattern 4 and to store these coordinates by associating them, directly or indirectly, in the database 14 with one or more variable information 5; it is therefore possible to take the image 11 with any photographic means, by way of example also a simple smartphone 15 or mobile phone provided with an embedded camera and by a specific application, the image is sent to a remote server 13 that searches, in the association database 14 connected therewith, for the corresponding reference image 12, i.e. the image of the same label 10 taken during the production process. By specific algorithms a software, installed in the machine 13, is able to assess the authenticity of the label on the market by analyzing the image.

In such a case, the authentication is possible by comparing the coordinates of the elements 3 themselves and those obtained from the reference image 12. In this case, advantages relating to the reduction of data amounts to be stored per every reference images 12 are evident.

In order to understand the effectiveness of the described process and method it is necessary to understand the work a possible producer would have to carry out if he wants to produce malevolently some “cloned” labels. He would have to: a) make a fabric piece with the same first woven pattern 2 and the same weaving threads; b) printing through one or more printing process, at least one of them being digital, the second decorating pattern; and c) he would have to print the provided variable information 5 on the label. Since from point a) he would have difficulties as the dishonest producer is at most able to know only the first woven pattern present on a real label he purchased, but he is not able to extrapolate the first woven patterns 2 of other labels. Therefore, in point b) he would have three problems to solve: (i) he knows only the pattern and variable data of the labels 10 he has and, therefore, he can only reproduce these patterns; hence, (ii) he would have to reproduce an image equal also in defects, thing difficult to realize especially with the digital printing on fabric, (iii) he would have to align the print with the first woven pattern 2 with a precision higher than the resolution of the image taken by the original producer, in order to store a “digital fingerprint” of the image. This third problem cannot be solved, in the state of the known art and/or with unitary costs lower than profit margins following the sale of a counterfeited item.

The Applicant believes that, on the basis of innumerable tests and tries of label replication, it's arguable that labels made by the above described process are not replicable with reasonable costs (a reasonable cost being a cost lower than the profit margin available from the sale of a counterfeited item net of the cost for making the cloned label). As a matter of fact photo resolutions (pixel sizes), both with low resolution during the production step and medium/high resolution obtainable by apparatuses on the market, are widely lower than tolerances of reciprocal positioning obtainable by the fabric printing. Only by way of example, a camera available on the market of 10 Megapixels has, on an image of 50*50 mm area, a definition power (pixel sizes) lower than 0.025 mm (obtained by dividing 50 mm by 2400 presumable pixels for the lower side of a 16:9 image) where, in the state of the art, it is practically impossible to position the first woven pattern 2 and the second decorating pattern 4 with a tolerance lower than one millimeter. In confirmation of what above, it has to be mentioned that the fabric is flexible, deformable in the plane and has a size unstable with thermal variations, it has a not-defined border and neither the position of the first woven pattern is known with respect to the border of the fabric piece 7 and, furthermore, it has to be noted that alignments to be observed, which are on the two plane dimensions (X axis and Y axis), complicate the label cloning of a 2 exponent.

Moreover, the Applicant wants to remark that labels made in accordance with the afore described techniques can be still definitely authenticated even after considerable wear. Neither washes nor auxiliary processes or wear indeed are able to change reciprocal positions of the first woven pattern 2 with respect to the second decorating pattern 4; a possible discoloration and/or surface wear of the fabric do not corrupt the visibility of the first woven pattern 2 nor the position of the second decorating pattern 4 with respect to it.

The present invention has been described referring to some embodiments. To the embodiments herein represented in detail various modifications can be made, comprising the shapes of the woven patterns, anyway remaining in the protection scope of the invention, defined by the following claims.

1. A process for making a fabric label containing one piece of unique information; said process comprising:
providing a fabric piece comprising a first woven pattern made by a predetermined arrangement combination of weft threads with respect to warp threads;
applying at least one second decorating pattern on said fabric piece to make at least one decoration for at least one label to be made;
associating at least one piece of variable label identifying information with with each said label;
detecting a reference image for each said second decorating pattern, assoicated with a label of the at least one label; each reference image being adapted to show the reciprocal position of each said second decorating pattern with respect to the first woven pattern; and
storing in a database said reference image or a resumptive parameter of said reference image.

2. The process for making a fabric label according to claim 1, wherein said applying at least one second decorating pattern comprises printing said at least one second decorating pattern on said fabric piece.

3. The process for making a fabric label according to claim 1, wherein said applying at least one second decorating pattern comprises:
printing said at least one second decorating pattern on a medium; and
transferring, on said fabric piece, the printed at least one second decorating pattern.

4. The process for making a fabric label according to claim 1, wherein said storing comprises electronically storing each said second decorating pattern associated with a label of the at least one label and, in conjunction with an associated piece of said at least one piece of variable label identifying information.

5. The process for making a fabric label according to claim 1, further comprising cutting said fabric piece to make at least one said label.

6. The process for making a fabric label according to claim 1, wherein, in said applying at least one second decorating pattern on said fabric piece, a plurality of said second decorating patterns is applied, each adapted to be positioned on an associated label of the at least one label.

7. The process for making a fabric label according to claim 1, wherein at least one of the weft threads and the warp threads comprise pigments visible if illuminated with light in the ultraviolet ray range.

8. The process for making a fabric label according to claim 1, wherein at least one of the weft threads and the warp threads comprise pigments visible if illuminated with light in the infrared ray range.

9. The process for making a fabric label according to claim 1, wherein said piece of varibable label identifying information is unique for every said label and is contained in an alphanumeric code, a mono-dimensional code or a two-dimensional code.

10. The process for making a fabric label according to claim 1, wherein said detecting a reference image comprises making a digital picture.

11. The process for making a fabric label according to claim 1, further comprising:
calculating coordinates of distinctive elements of the first woven pattern, or parts thereof, with respect to reference points of the second decorating pattern; and
storing said coordinates in a database (14) in conjunction with an associated piece of said variable label identifying information, or piece of information associated therewith.

12. The process for making a fabric label according to claim 1, further comprising authenticating the fabric label by:
providing a first label of the at least one label of which the authenticity has to be verified;
detecting an image of the first label; and
comparing the detected image with a reference one in order to verify that the reciprocal position of the woven pattern, with respect to the second decorating pattern present on the detected image, is identical to the reciprocal position of the woven pattern with respect to the second decorating pattern present on the reference image.

13. The process for making a fabric label according to claim 12, further comprising:
calculating coordinates of distinctive elements of the first woven pattern, or parts thereof, with respect to reference points of the second decorating pattern, and
comparing such coordinates with the coordinates of the distinctive elements, or parts of them, detected in the reference image.

14. The process for making a fabric label according to claim 12, wherein said step of detecting an image comprises making a digital picture.

15. The process for making a fabric label according to claim 12, wherein said comparing the detected image with a reference one comprises sending the reference image from a remote server associated with a database containing the reference images to a smartphone, tablet, or PC or displaying means of said reference image.

16. A label obtainable by the process according to claim 1.

17. A fabric label apparatus comprising a fabric comprising weft threads and warp threads woven together to form a woven pattern;
said woven pattern including at least one distinctive element formed of a specific and controlled arrangement of the weft threads with respect to the warp threads or by embroidering a pattern on the fabric piece;
said fabric label apparatus further comprising at least one second decorating pattern disposed thereon and associated with an individual label of a plurality of labels and at least one piece of variable information adapted to identify each said individual label disposed thereon;
wherein a reciprocal position of said at least one distinctive element, with respect to said second decorating pattern realizes an authenticity element of an associated individual label.

18. The fabric label apparatus according to claim 16, wherein each said second decorating pattern is uniquely associated with an individual label of said plurality of labels and different from other said second decorating patterns associated with further labels.

19. Anti-counterfeiting system of a label, comprising:
at least one label made of fabric comprising a first woven pattern; said woven pattern comprising at least one distinctive element obtained through a specific and controlled arrangement of the weft threads with respect to the warp threads and/or by an embroidery; said label further comprising at least one second decorating pattern applied on said fabric and at least one piece of variable information adapted to identify a single label;
the reciprocal position of said at least one distinctive element, with respect to said second decorating pattern, realizing an authenticity element of the same label;
at least one means for detecting the reciprocal position of said at least one distinctive element with respect to said second decorating pattern;
at least one means for storing the reciprocal position of said at least one distinctive element with respect to said second decorating pattern.

20. The process for making a fabric label according to claim 1, wherein said providing a fabric piece further includes a full or partial embroidery on the fabric piece.
